(19) United States
(12) Patent Application Publication
(10) Pub. No.: US 2012/0119689 A1
(43) Pub. Date: May 17, 2012

(54) MOTOR CONTROL SYSTEM

(75) Inventors: Jun YAMADA, Nagoya-city (JP); Masaaki Shinojima, Chiryu-city (JP); Kiyoshi Kimura, Kariya-city (JP)

(73) Assignee: DENSO CORPORATION, Kariya-city (JP)

(21) Appl. No.: 13/280,657

(22) Filed: Oct. 25, 2011

(30) Foreign Application Priority Data
Nov. 15, 2010 (JP) 2010-255290

(51) Int. Cl. G05B 11/01

(52) U.S. Cl. 318/630

(57) ABSTRACT

An amount of a rotational angle corresponding to a half of a play (included in an insert-fit coupling device having a maximum production tolerance) is set as a correction amount. When a shift range is changed to a target range, a target rotational angle for an output shaft corresponding to such target range is calculated. The target rotational angle is corrected to get a virtual rotational angle for the output shaft, so that the output shaft may be further rotated by the correction amount in addition to the target rotational angle. A control error for a stop position of a roller is controlled within a half of the play. According to the invention, it is not necessary to carry out a learning process for the play.

### CROSS REFERENCE TO RELATED APPLICATION

This application is based on Japanese Patent Application No. 2010-255290 filed on Nov. 15, 2010, the disclosure of which is incorporated herein by reference.

### FIELD OF THE INVENTION

The present invention relates to a motor control system and an apparatus, according to which an output shaft is connected to a rotor shaft of an electric motor via a rotation transmitting device (such as, a speed reduction gear) and a controlled system is operated by the output shaft.

### BACKGROUND OF THE INVENTION

In recent years, a mechanical driving system is changed to an electrical driving system having an electric motor in automotive vehicles, in order to fulfill requirements for space-saving, improvements of assembling performance, increase of controllability and so on. As one of examples of such electrical driving systems, it is known in the art that a shift-range changing device of an automatic transmission apparatus for a vehicle is operated by an electric motor. According to such a system, an output shaft is connected to a rotor shaft of the electric motor via a speed reduction gear and the shift-range changing device is driven by the output shaft so as to change a shift range of the automatic transmission apparatus. In this system, an encoder is provided in the electric motor in order to detect a rotational angle (a rotational position). And when the shift range is changed, the electric motor is rotated to a target rotational angle (a target counting value) corresponding to a target shift range, based on a counting value of output pulses from the encoder, so that the shift range of the automatic transmission apparatus is changed to the target range by the shift-range changing device.

A rotational amount (a rotational angle) of the motor is converted into an operational amount for the shift-range changing device via a driving power transmitting system (such as, the speed reduction gear). There exists a play (a clearance) among parts constituting the driving power transmitting system. For example, the speed reduction gear has a play (so-called a back-lash) among multiple gears. In addition, a forward end (a coupling portion) of an output shaft of the speed reduction gear, which is formed in a non-circular shape in cross-section (for example, a square shape, a D-shape, a spline shape, and so on), is inserted into a fitting hole of the shift-range changing device, so that the speed reduction gear is connected to the shift-range changing device. Therefore, it is necessary to provide a clearance between the forward end of the output shaft and the fitting hole, in order to smoothly insert the forward end into the fitting hole.

As above, the play (the back-lash, the clearance, or the like) exists in the driving power transmitting system for converting the rotational amount of the motor into the operational amount of the shift-range changing device. As a result, even when the rotational angle of the motor can be precisely controlled based on a detection signal from a rotational angle sensor, the operational amount for the shift-range changing device may include a control error corresponding to the play of the driving power transmitting system. It is, therefore, not possible to precisely control the operational amount for the shift-range changing device.

According to a prior art, for example, as disclosed in Japanese Patent Publication No. 2005-198449, a rotational angle detecting device for an output shaft is provided for detecting a rotational angle of the output shaft, in order that a target rotational angle of a motor is corrected by use of a detected rotational angle of the output shaft (detected by the rotational angle detecting device for the output shaft)

According to a structure, in which an output shaft of a motor is connected to a shift-range changing device via a coupling device having a play, it is not possible to eliminate an influence of the play included in the coupling device between the output shaft and the shift-range changing device, even when a rotational angle detecting sensor is provided for detecting a rotational angle of the output shaft of the motor.

According to another prior art, for example, as disclosed in Japanese Patent Publication No. 2006-136035, a bumping control is carried out. More exactly, a motor is rotated until an engaging portion of a detent lever bumps into a limit position (a wall) of a movable range of a shift-range changing device, in order to learn an amount of a play included in a driving power transmitting system. Then, a target rotational angle is corrected based on such a learning value.

When the above bumping control is carried out, namely when the engaging portion of the detent lever is moved to bump into the limit position (the wall) of the movable range of the shift-range changing device, in order to learn the amount of the play, a load is applied to respective portions of the driving power transmitting system and thereby a durability of the shift-range changing device may be decreased.

According to a further prior art, for example, as disclosed in Japanese Patent Publication No. 2009-177965, an electric motor is rotated in a forward direction and in a backward direction with such a small torque, that a shift range of a shift-range changing device can not be moved and remains in the current position, for example, in a P-range. In this operation, the motor is rotated until an output shaft of the motor bumps into an opposite side of a play included in a coupling device, so as to detect (learn) both sides of the play. Then, a target rotational angle is corrected based on such learning value.

According to the above prior arts (JP No. 2006-136035, JP No. 2009-177965), however, the amount of the play is detected (learned) and the target rotational angle is corrected based on such learning value. Therefore, it is necessary in the above prior arts to carry out a process for learning the amount of the play. It is a problem that a calculating load for a control circuit may be increased. In addition, it is difficult to accurately learn the amount of the play. When an error in a learning process for the amount of the play (a detection error) is increased, a control accuracy for the shift-range changing device is correspondingly decreased. It may become difficult to assure the control accuracy for the shift-range changing device.

### SUMMARY OF THE INVENTION

The present invention is made in view of the above problems. It is an object of the present invention to provide a motor control apparatus, according to which a calculation load to a control circuit will be reduced and a control accuracy for a controlled system is assured.

According to a feature of the invention, a motor control system has an electric motor; a motor position detecting device for detecting a rotational angle of the electric motor; an output shaft connected to a rotor shaft of the electric motor via a rotation transmitting system; and a controlled device connected to the output shaft via a coupling device.

The motor control system further has a motor control apparatus. When an operational position of the controlled device is moved to a target operational position, the motor control apparatus sets a target rotational angle for the electric motor, which corresponds to the target operational position of the controlled device, and the motor control apparatus further drives the electric motor until a detected rotational angle of the electric motor detected by the motor position detecting device becomes equal to or closer to the target rotational angle for the electric motor.

The motor control apparatus has a motor position setting portion for setting the target rotational angle for the electric motor so that the target rotational angle for the electric motor includes a basic rotational angle for the output shaft necessary for moving the operational position of the controlled device to the target operational position and a correction amount.

According to another feature of the invention, a motor control system has an electric motor; a motor position detecting device for detecting a rotational angle of the electric motor; an output shaft connected to a rotor shaft of the electric motor via a rotation transmitting system; and a controlled device connected to the output shaft via a coupling device having a play.

The motor control system further has a motor control apparatus. When an operational position of the controlled device is moved to a target operational position, the motor control apparatus sets a target rotational angle for the electric motor, which corresponds to the target operational position and drives the electric motor until a detected rotational angle of the electric motor detected by the motor position detecting device becomes equal to or closer to the target rotational angle for the electric motor. The motor control apparatus has a motor position setting portion for setting the target rotational angle for the electric motor by use of a correction amount which is calculated based on a predetermined amount of the play.

According to the above feature, since the target rotational angle for the motor is set by the correction amount, which is calculated based on a predetermined amount of the play, it is not necessary to carryout a learning process for the amount of the play and thereby to reduce a calculating load of a control circuit. In addition, since the correction amount (a constant amount) based on the predetermined amount of the play is used, the motor control system of the present invention may not receive any influence, which would be caused by a learning error (a detection error) for the amount of the play in a conventional system. It is, therefore, possible to prevent a control accuracy of the controlled system from largely becoming worse, and thereby to properly assure the control accuracy of the controlled system.

According to a further feature of the invention, the motor control system has an output-shaft position detecting device for detecting a rotational angle of the output shaft, and an output-shaft position setting portion for setting a target rotational angle for the output shaft, corresponding to the target operational position. The motor position setting portion corrects the target rotational angle for the output shaft by use of the correction amount, calculates a deviation between a corrected target rotational angle for the output shaft and a detected rotational angle of the output shaft detected by the output-shaft position detecting device, multiplies the deviation by a reduction ratio of the rotation transmitting system, and calculates the target rotational angle for the electric motor by use of such a multiplied value.

According to such a feature of the invention, it is possible to precisely set the target rotational angle for the electric motor by use of the correction amount, which is calculated based on the predetermined amount of the play.

According to a further feature of the invention, the correction amount is set at such an amount of the rotational angle, which corresponds to a half of the play, and the motor position setting portion corrects the target rotational angle for the output shaft in such a manner that the output shaft is further rotated by the correction amount in addition to the target rotational angle for the output shaft, when the motor position setting portion corrects the target rotational angle for the output shaft by use of the correction amount.

According to such a feature of the invention, it is possible to change the operational position of the controlled system to the target position with a proper accuracy.

According to a still further feature of the invention, the predetermined amount of the play is set to be a value, which corresponds to an amount of a play included in the coupling device having a maximum production tolerance. In other words, the correction amount is set at an amount of the rotational angle, which corresponds to a half amount of the play included in the coupling device having the maximum production tolerance.

According to such a feature, it is possible to suppress the control accuracy of the controlled system less than the half amount of the play of the coupling device having the maximum production tolerance, irrespectively of an actual size of the amount of the play.

According to a still further feature of the invention, a motor control system has; an electric motor; a motor position detecting device for detecting a rotational angle “θ1” of the electric motor; an output shaft connected to a rotor shaft of the electric motor via a rotation transmitting system; an output-shaft position detecting device for detecting a rotational angle “θ2” of the output shaft; a controlled device connected to the output shaft via a coupling device having a play; and a motor control apparatus for controlling the rotational angle “θ1” of the electric motor so that an operational position of the controlled device is moved to a target operational position.

In the above motor control system, the motor control apparatus calculates a target rotational angle “θ3tg” for the output shaft, which corresponds to the target operational position, and the motor control apparatus calculates a virtual target rotational angle “θ2tg” in accordance with a following formula 1;

θ2tg=θ3tg±θBmax/2, formula 1:

wherein θ“θBmax/2” is a correction amount calculated based on a predetermined amount of the play included in the coupling device.

The motor control apparatus further calculates a target rotational angle “θ1tg” for the electric motor in accordance with a following formula 2;

θ1tg=(θ2−θ2tg)×Kg+θ1, formula 2:

wherein “Kg” is a reduction ratio of the rotation transmitting system.

The motor control apparatus drives the electric motor in a feed-back control so that a detected rotational angle “θ1” of the electric motor becomes equal to or closer to the target rotational angle “θ1tg” for the electric motor.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic perspective view showing a shaft-range changing device according to an embodiment of the present invention;

FIG. 2 is a schematic block diagram showing a structure of a motor control system for the shift-range changing device;

FIG. 3 is a schematic plan view showing a detent lever and its related portions;

FIG. 4 is a schematic block diagram showing a structure of a system for a feed-back control of a motor;

FIG. 5 is a time chart for explaining a feed-back control operation of the motor;

FIG. 6 is a schematic view for explaining a setting process of a virtual target rotational angle “θ2tg” for an output shaft;

FIG. 7 is a schematic view for explaining a problem of a conventional system;

FIGS. 8A and 8B are schematic views for explaining a control error, in a case an amount of a play “θBr” of a coupling portion is equal to a maximum amount of the play “θBmax”;

FIGS. 9A and 9B are schematic views for explaining the control error, in a case the amount of a play “θBr” of the coupling portion is smaller than the maximum amount of the play “θBmax”;

FIG. 10 is a view for explaining the control error, in a case the amount of the play “θBr” at the coupling portion is equal to zero “0”;

FIG. 11 is a flowchart showing a process of a main routine;

FIG. 12 is a flowchart showing a process of a routine for setting a target rotational angle of the motor;

FIG. 13 is a flowchart showing a process of a routine for a motor feed-back control; and

FIG. 14 is a flowchart showing a process of a routine for calculating a virtual target rotational angle “θ2tg” of an output shaft.

### DETAILED DESCRIPTION OF THE PREFERRED EMBODIMENTS

The present invention will be explained hereinafter by way of an embodiment, in which the present invention is applied to a shift-range changing device of a motor-driven type.

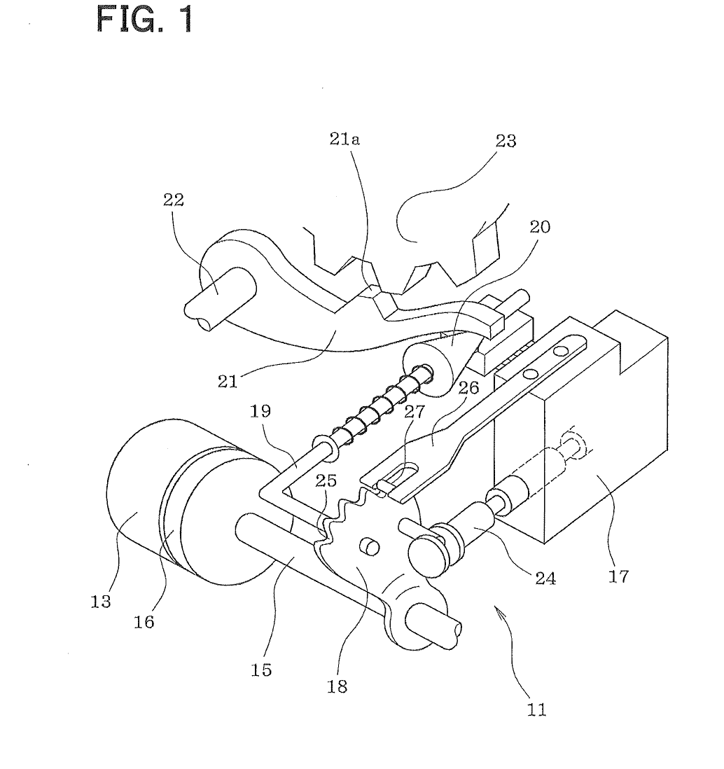

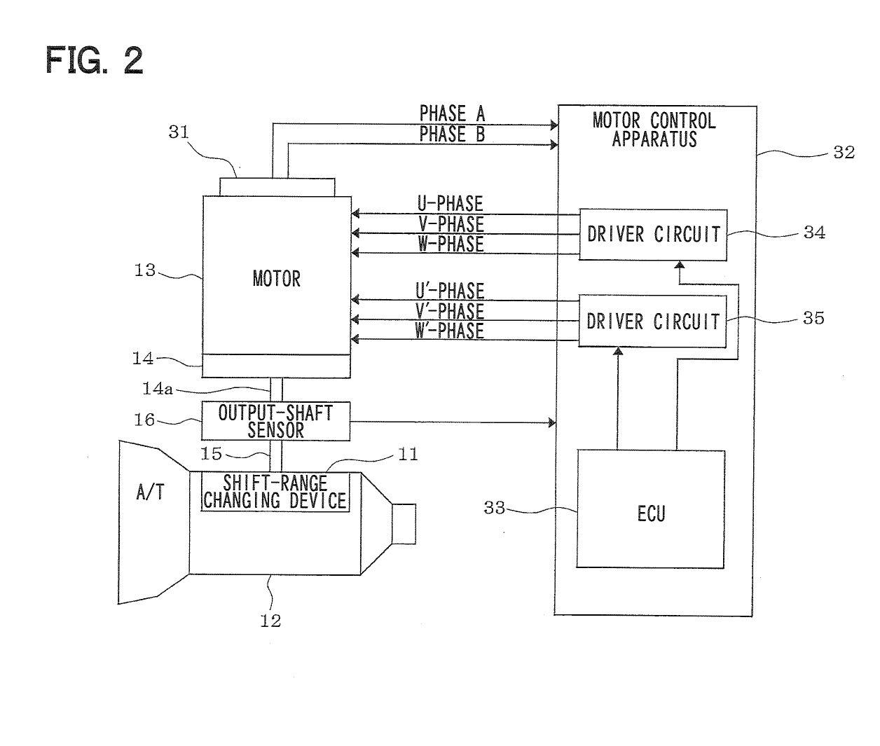

A structure of the shift-range changing device 11 will be explained with reference to FIG. 1 and FIG. 2.

The shift-range changing device 11 is a device for changing a gear range of an automatic transmission apparatus 12 to one of the gear ranges, such as, a parking range (P), a reverse range (R), a neutral range (N), and a drive range (D). An electric motor 13, which is a driving source of the shift-range changing device 11, is composed of a synchronous motor, such as, a switched reluctance motor (SR motor) and houses a speed reduction gear 14 (FIG. 2). An output-shaft sensor 16 is provided at an output shaft 14a of the speed reduction gear 14 for detecting a rotational angle of the output shaft 14a. The output-shaft sensor 16 is also referred to as an output-shaft position detecting device.

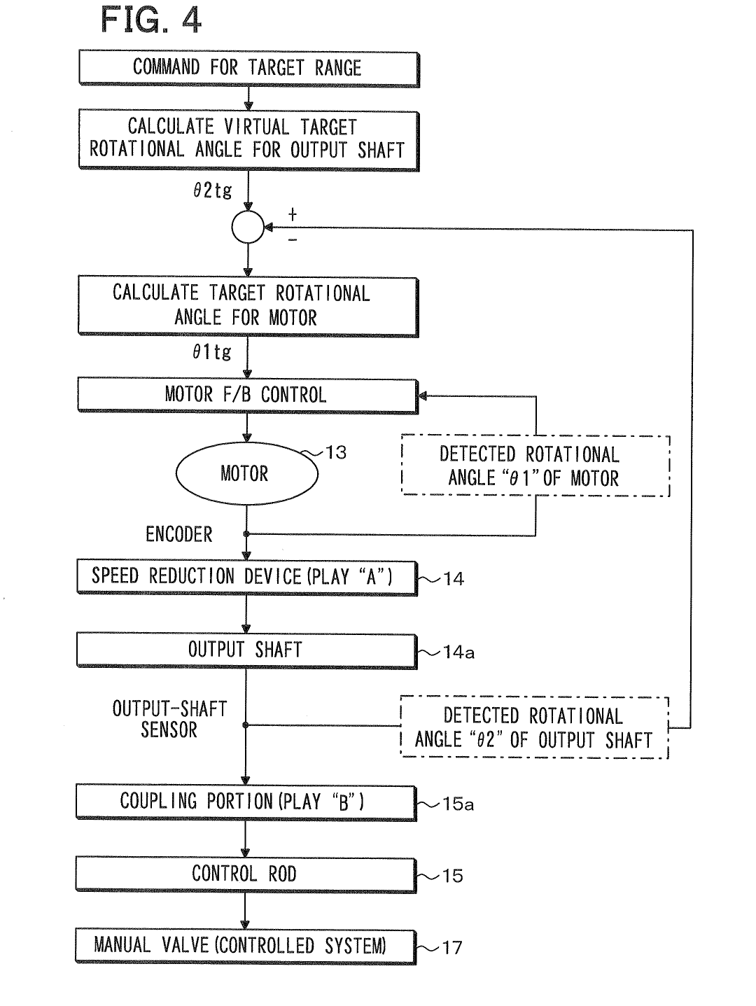

A control rod 15 of the shift-range changing device 11 is connected to the output shaft 14a of the speed reduction gear 14 via a coupling portion 15a (FIG. 4), which has a play. Although not shown in the drawing, a forward end of either the output shaft 14a or the control rod 15 is formed in a non-circular shape in cross-section, while a fitting hole is formed at a forward end of the other of the output shaft 14a or the control rod 15. The non-circular forward end is inserted into the fitting hole so that the control rod 15 is connected to the output shaft 14a and thereby the rotation of the output shaft 14a is transmitted to the control rod 15. Such a coupling portion between the non-circular forward end and the fitting hole is also referred to as an insert-fit coupling device 15a.

A detent lever 18, which changes a manual valve 17 of a hydraulic circuit for the automatic transmission apparatus 12, is fixed to the control rod 15. A parking rod 19 of an L-letter shape is connected to the detent lever 18. A conical member 20 formed at a forward end of the parking rod 19 is in contact with a locking lever 21.

The locking lever 21 is rotated at a shaft 22 in accordance with a position of the conical member 20. In other words, the locking lever 21 is moved in a vertical direction (in an upward or a downward direction), so that it locks or unlocks a parking gear 23. The parking gear 23 is provided at a drive shaft of the automatic transmission apparatus 12. When the parking gear 23 is locked by the locking lever 21, driving wheels of a vehicle are maintained in a condition (a parking condition) that the driving wheels can not be rotated.

A spool valve 24 of the manual valve 17 is connected to the detent lever 18. When the output shaft 14a is rotated by the motor 13, the detent lever 18 is rotated together with the control rod 15. An operational amount of the manual valve 17 (that is, a position of the spool valve 24) is changed so as to change the shift range of the automatic transmission apparatus 12 to one of the P-range, the R-range, the N-range and the D-range. Four recessed portions 25 are formed at the detent lever 18 in order to hold the spool valve 24 at such positions, each of which respectively corresponds to the above shift ranges.

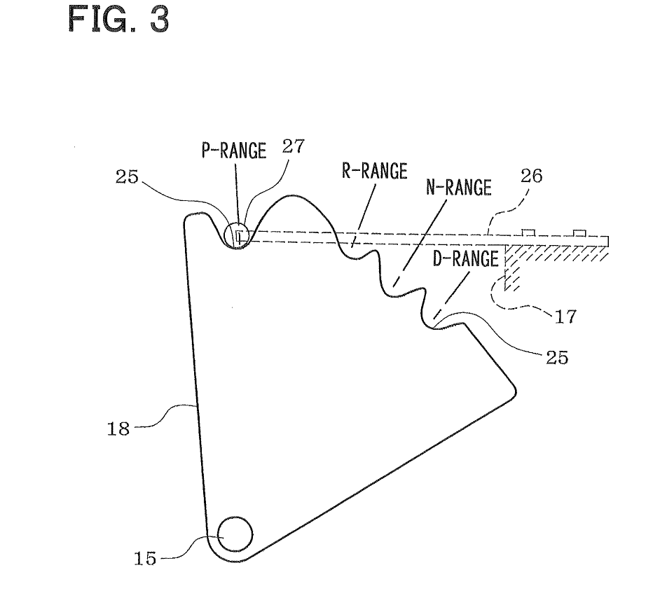

As shown in FIG. 3, a detent spring 26 is connected to the manual valve 17 for holding the detent lever 18 at the position corresponding to each of the shift ranges. A roller 27 (an engaging portion) is provided at a forward end of the detent spring 26. When the roller 27 is inserted into (and engaged with) the recessed portion 25 of a target shift range, the detent lever 18 is maintained at a rotational angular position corresponding to the target shift range. As a result, the spool valve 24 of the manual valve 17 is held at a position of the target shift range.

When the shift range is in the P-range, the parking rod 19 is moved in a direction closer to the locking lever 21, so that a thicker portion of the conical member 20 pushes up the locking lever 21. A projection 21a of the locking lever 21 is brought into an engagement with the parking gear 23 so as to lock the parking gear 23. As a result, the drive shaft of the automatic transmission apparatus 12 (that is, the driving wheels) is held in the locked condition (the parking condition).

When the shift range is in the other ranges than the P-range, the parking rod 19 is moved in a direction away from the locking lever 21, so that the thicker portion of the conical member 20 is brought out of contact with the locking lever 21. Namely, the locking lever 21 is moved in the downward direction, so that the projection 21a of the locking lever 21 comes out of the engagement with the parking gear 23. The locked condition of the parking gear 23 is thereby released and the drive shaft of the automatic transmission apparatus 12 is maintained in a condition that the drive shaft is rotatable (in a condition that the vehicle can run).

According to the present embodiment, the output-shaft sensor 16 is composed of a rotational angle sensor (for example, a potentiometer), an output voltage of which is changed in a linear manner depending on the rotational angle of the output shaft 14a of the speed reduction device for the motor 13. Based on the output voltage, it is possible to detect and confirm a current rotational angle of the output shaft 14a, namely it is possible to detect a current shift range, among the P-range, the R-range, the N-range and the D-range.

An encoder 31 (a motor position detecting device) is provided in the electric motor 13 for detecting a rotational angle of a rotor. The encoder 31 is, for example, composed of a magnetic type rotary encoder. The encoder 31 generates pulse signals of A-phase and B-phase in synchronism with the rotation of the rotor of the motor 13. The pulse signals are outputted to a control device 32 for changing the shift range. An ECU 33 of the control device 32 counts both of rising edges and falling edges of the pulse signals of A-phase and B-phase from the encoder 31. The ECU 33 changes current supply phases of the motor 13 in a predetermined order by motor driver circuits 34 and 35, depending on such encoder counting value, so that the motor 13 is driven to rotate.

In the above operation, the ECU 33 determines a rotational direction based on an order of generation of the pulse signals of A-phase and B-phase. In a case of the rotation in a forward direction (that is, the rotation in a direction from the P-range to the D-range), the encoder counting value is increased (counted up). In a case of the rotation in a backward direction (that is, the rotation in a direction from the D-range to the P-range), the encoder counting value is decreased (counted down). According to such a process, it is possible to maintain a relationship between the encoder counting value and the rotational angle of the motor 13, in the case the motor 13 is rotated in either direction of the forward or the backward direction. Accordingly, when the motor 13 is rotated in either of the forward direction or the backward direction, the ECU 33 can detect the rotational angle of the motor 13 based on the encoder counting value and carry out the current supply to such winding, a phase of which corresponds to the rotational angle, so as to rotate the motor 13.

Now, an outline of a feed-back control system (a F/B control system) for the motor 13 will be explained with reference to FIG. 4. The F/B control system for the motor 13 is composed of two F/B control systems. According to a first F/B control system, a target rotational angle “θ1tg” for the motor is calculated based on a deviation (θ2-θ2tg) between a detected rotational angle “θ2” of the output shaft detected by the output-shaft sensor 16 and a virtual target rotational angle “θ2tg” for the output shaft (explained below), in accordance with the following formula:

θ1tg=(θ2−θ2tg)×Kg+θ1

In the above formula, “Kg” is a speed reduction ratio of a rotation transmitting system (the speed reduction gear 14), and “θ1” is a detected rotational angle of the motor based on the encoder 31.

In other words, the first F/B control system is a sub F/B control system, according to which the target rotational angle “θ1tg” for the motor is corrected based on the deviation (θ2-θ2tg) between the detected rotational angle “θ2” of the output shaft detected by the output-shaft sensor 16 and the virtual target rotational angle “θ2tg” of the output shaft.

On the other hand, a second F/B control system is a main F/B control system, according to which a motor F/B control is carried out in order to drive the motor 13 to the target rotational angle “θ1tg” for the motor. In the above motor F/B control, the winding phases of the motor 13 for the current supply are sequentially changed based on the detected rotational angle “θ1” of the motor based on the encoder 31 (that is, the encoder counting value).

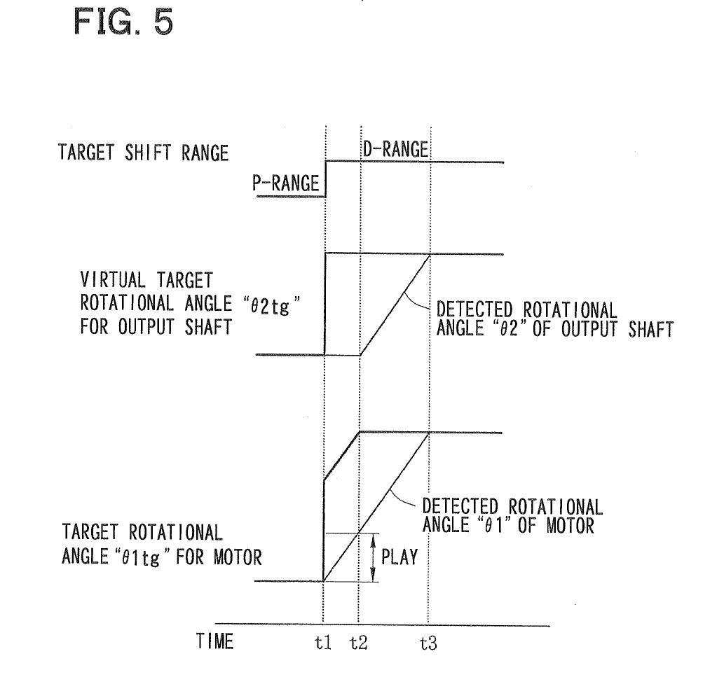

An example of the control for the motor 13 by the above two F/B control systems will be explained with reference to FIG. 5. At a time point t1, at which a vehicle driver operates a shift lever for the automatic transmission apparatus 12 from the P-range to the D-range, the ECU 33 calculates (sets) the virtual target rotational angle “θ2tg” for the output shaft, which corresponds to a target range changed by the operation of the shift lever. Then, the ECU 33 calculates the target rotational angle “θ1tg” for the motor based on the deviation (θ2-θ2tg) between the detected rotational angle “θ2” of the output shaft detected by the output-shaft sensor 16 at the time point t1 and the virtual target rotational angle “θ2tg” for the output shaft. An operation for driving the electric motor 13 is started.

During a period shortly after the start of operation for the motor 13, in other words, in a period by such a time point in which the motor 13 is rotated by an angle corresponding to a play “A” of the speed reduction device 14 (shown in FIG. 4), only the motor 13 is rotated and the output shaft 14a is not rotated. Therefore, the detected rotational angle “θ2” of the output shaft is not changed in the output-shaft sensor 16. However, the detected rotational angle “θ1” of the motor is changed in the encoder 31 in accordance with the rotation of the motor 13. As a result, the target rotational angle “θ1tg” for the motor is correspondingly changed in accordance with the change of the detected rotational angle “θ1” of the motor.

At a time point t2, at which the motor 13 has been rotated by the play “A” of the speed reduction device 14, the output shaft 14a starts rotation together with the motor 13. Then, the detected rotational angle “θ2” of the output shaft likewise starts its change. After this time point t2, since the output shaft 14a integrally rotates with the motor 13, the target rotational angle “θ1tg” for the motor is maintained at a constant value.

At a time point t3, at which the detected rotational angle “θ1” of the motor by the encoder 31 becomes equal to the target rotational angle “θ1tg” for the motor, the motor operation is stopped. According to the above process, the change of the shift range is completed.

As shown in FIG. 4, there exists another play “B” in the coupling portion 15a between the output shaft 14a of the speed reduction device 14 for the motor 13 and the control rod 15 of the shift-range changing device 11. As a result, an error, which corresponds to the play “B” of the coupling portion 15a between the rotational angle of the output shaft 14a and the rotational angle of the control rod 15, may be generated.

According to the present embodiment, such an amount of a rotational angle, which corresponds to a half (½) of a predetermined amount of the play, is set as a correction amount. The predetermined amount of the play is set to be, for example, a value corresponding to an amount of the play “θBmax” of such a coupling portion (15a) which has a maximum production tolerance (that is, the coupling portion having an upper limit of the production tolerance). The amount of the play “θBmax” is also referred to as “a maximum amount of the play”. Accordingly, the correction amount is set at such an amount of the rotational angle (θBmax/2), which corresponds to a half (½) of the maximum amount of the play “θBmax”.

The detent lever 18 is so formed that a slide-off range of each recessed portion 25 is larger than the maximum amount of the play “θBmax”. The slide-off range is a distance (or a width) of each recessed portion 25 in a rotational direction, within which the roller 27 slides off into the recessed portion 25 to a center bottom portion thereof by itself or a spring force of the detent spring 26. More exactly, the slide-off range includes such a range, which has a width of a half of the maximum amount of the play “θBmax” (=θBmax×½) with respect to the center bottom portion of the recessed portion 25.

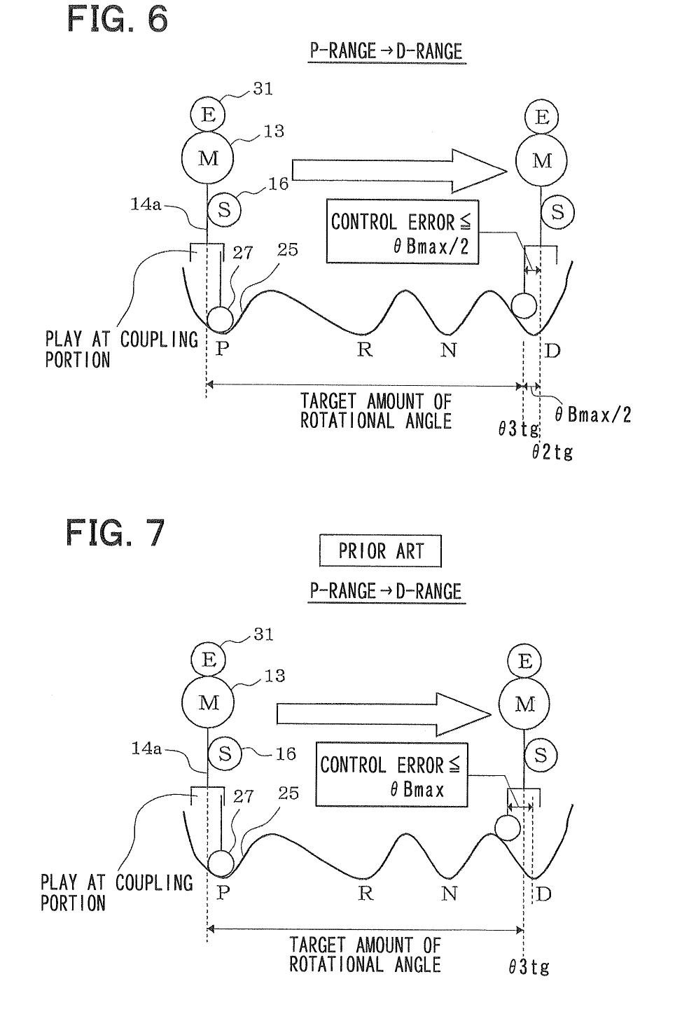

As shown in FIG. 6, in the case of changing the shift range to the target range, that is, the D-range in the present embodiment, a target rotational angle “θ3tg” for the output shaft corresponding to the target range is calculated (set) based on the current rotational position of the output shaft 14a (that is, the detected rotational angle “θ2” of the output shaft detected by the output-shaft sensor 16) and a target amount of the rotational angle for the output shaft 14a necessary for changing the shift range to the target range (that is, an amount of the rotational angle from a center bottom position of the recessed portion 25 for the current shift range to a center bottom position of the recessed portion 25 for the target shift range). Then, the target rotational angle “θ3tg” for the output shaft is corrected by the correction amount (θBmax/2), to thereby obtain the virtual target rotational angle “θ2tg” for the output shaft.

Namely, the target rotational angle “θ3tg” for the output shaft is so corrected and the virtual target rotational angle “θ2tg” for the output shaft is so decided that the output shaft 14a is rotated further by the correction amount (θBmax/2) in addition to the target rotational angle “θ3tg” for the output shaft.

The above target rotational angle “θ3tg” for the output shaft is also referred to as a basic rotational angle “θ3tg” for the output shaft necessary for moving the current shift range (an operational position) to the target range (a target operational position).

The above virtual target rotational angle “θ2tg” for the output shaft is also referred to as a corrected target rotational angle for the output shaft. The above center bottom position of the recessed portion 25 for the target shaft range is also referred to as a basic position, which corresponds to the target rotational angle “θ3tg” (the basic rotational angle “θ3tg”) for the output shaft.

For example, when the shift range is changed from the P-range to the D-range, the virtual target rotational angle “θ2tg” for the output shaft is set at such a position, which is displaced from a position of the target rotational angle “θ3tg” for the output shaft in a direction to the D-range (in the direction from the P-range to the D-range) by the correction amount (θBmax/2).

θ2tg=θ3tg+θBmax/2

On the other hand, when the shift range is changed from the D-range to the P-range, the virtual target rotational angle “θ2tg” for the output shaft is set at such a position, which is displaced from the position of the target rotational angle “θ3tg” for the output shaft in a direction to the P-range (in the direction from the D-range to the P-range) by the correction amount (θBmax/2).

θ2tg=θ3tg−θBmax/2

According to a conventional method, the play “B” of the coupling portion 15a is not taken into consideration and the rotational angle of the output shaft 14a is so controlled as to be the target rotational angle “θ3tg” for the output shaft corresponding to the target shift range. Therefore, as shown in FIG. 7, an operation of the motor 13 (a relative movement of the roller 27 with respect to the detent lever 18) may be stopped short of a center bottom position of the recessed portion for the target shift range due to the play included in the coupling portion. When a stop position of the roller 27 is in the slide-off range, within which the roller 27 slides off into the recessed portion toward the center bottom position by itself or by the spring force of the detent spring 26, there occurs no problem because the roller 27 falls down to the center bottom position of the recessed portion 25 by itself after the stop of the operation for the motor 13. When the stop position of the roller 27 is short of the slide-off range, the roller 27 remains at such a stop position and it is not possible to make the roller 27 to slide off to the bottom portion of the recessed position 25.

According to the present embodiment, however, as shown in FIG. 6, the amount of the rotational angle (θBmax/2), which corresponds to the half of the maximum amount of the play “θBmax”, is set as the correction amount so as to correct the target rotational angle “θ3tg” for the output shaft and thereby to obtain the virtual target rotational angle “θtg” for the output shaft, in order that the output shaft 14a is further rotated by the correction amount (θBmax/2) in addition to the target rotational angle “θ3tg” for the output shaft. As a result, a control error for the stop position of the roller 27 can be made smaller than the half of the maximum amount of the play “θBmax”, for the purpose of controlling the rotational angle of the output shaft 14a to be the virtual target rotational angle “θ2tg” for the output shaft. The control error is a deviation between the center bottom position of the recessed portion 25 and an actual stop position of the roller 27. Accordingly, it is possible to surely bring the stop position of the roller within the slide-off range.

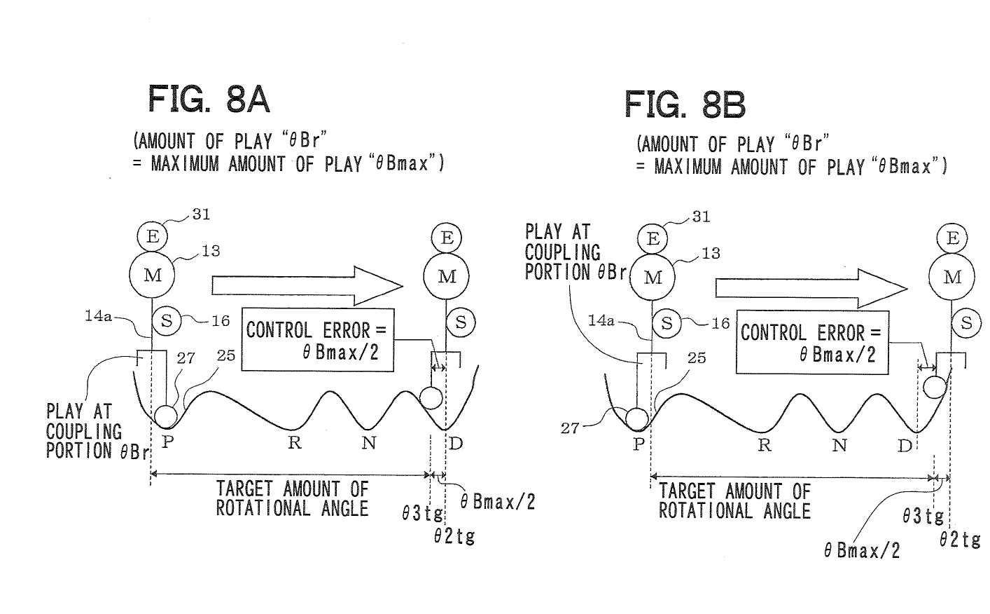

For example, FIGS. 8A and 8B show such cases, in which an actual amount of the play “θBr” of the coupling portion 15a is equal to the maximum amount of the play “θBmax”. As shown in FIG. 8A, when the shift range is moved from the P-range to the ID-range and when the play “θBr” exists on a backward side of the roller 27 in a forward direction of the movement (that is, a left-hand side of the roller 27 in FIG. 8A when the roller 27 is in the P-range), the stop position of the roller 27 is such a position which is displaced from the center bottom position of the recessed portion 25 for the D-range in the direction toward the P-range by the amount of “θBmax/2”. In other words, the control error for the stop position of the roller 27 is the half (½) of the maximum amount of the play “θBmax”.

On the other hand, as shown in FIG. 8B, when the shift range is moved from the P-range to the ID-range and when the play “θBr” exists on a forward side of the roller 27 in the forward direction of the movement (that is, a right-hand side of the roller 27 in FIG. 8B when the roller 27 is in the P-range), the stop position of the roller 27 is such a position which is displaced from the center bottom position of the recessed portion 25 for the D-range in the direction toward the D-range by the amount of “θBmax/2”. In other words, the control error for the stop position of the roller 27 is the half (½) of the maximum amount of the play “θBmax”.

As above, in case of FIG. 8A, the roller 27 is moved to be closer to the basic position corresponding to the basic rotational angle in the direction from the P-range to the D-range. In case of FIG. 8B, the roller 27 is moved to a position beyond the basic position.

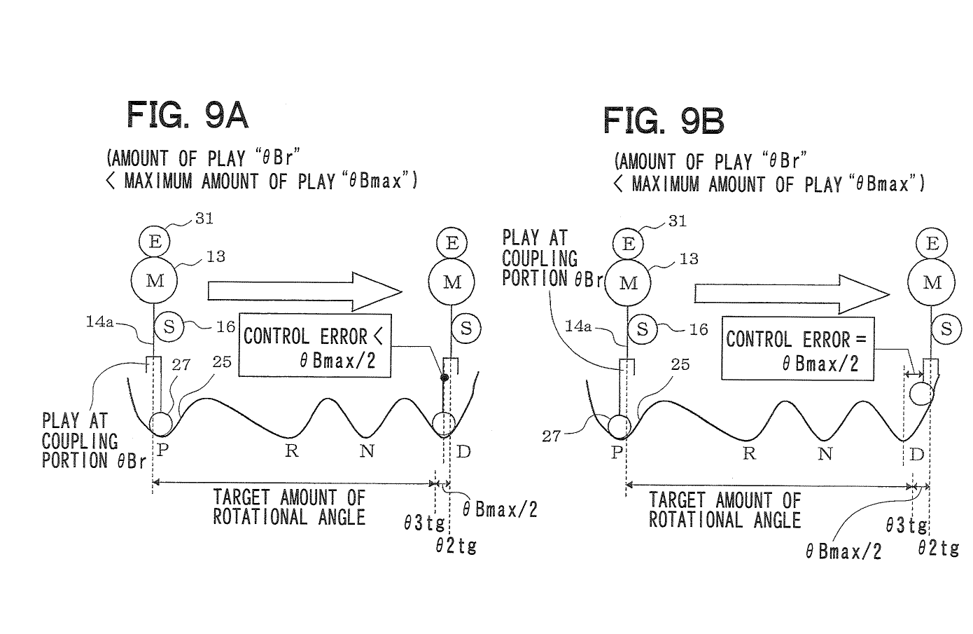

FIGS. 9A and 9B show such cases, in which the actual amount of the play “θBr” of the coupling portion 15a is smaller than the maximum amount of the play “θBmax”.

As shown in FIG. 9A, when the shift range is moved from the P-range to the D-range and when the play “θBr” exists on the backward side of the roller 27 in the forward direction of the movement (that is, the left-hand side of the roller 27 in FIG. 9A when the roller 27 is in the P-range), the stop position of the roller 27 is such a position which is displaced from the center bottom position of the recessed portion 25 for the D-range by the amount of “θBmax/2-θBr”. In other words, the control error for the stop position of the roller 27 becomes smaller than the half (½) of the maximum amount of the play “θBmax”.

On the other hand, as shown in FIG. 9B, when the shift range is moved from the P-range to the D-range and when the play “θBr” exists on the forward side of the roller 27 in the forward direction of the movement (that is, the right-hand side of the roller 27 in FIG. 9B when the roller 27 is in the P-range), the stop position of the roller 27 is such a position which is displaced from the center bottom position of the recessed portion 25 for the D-range in the direction toward the D-range by the amount of “θBmax/2”. In other words, the control error for the stop position of the roller 27 is the half (½) of the maximum amount of the play “θBmax”.

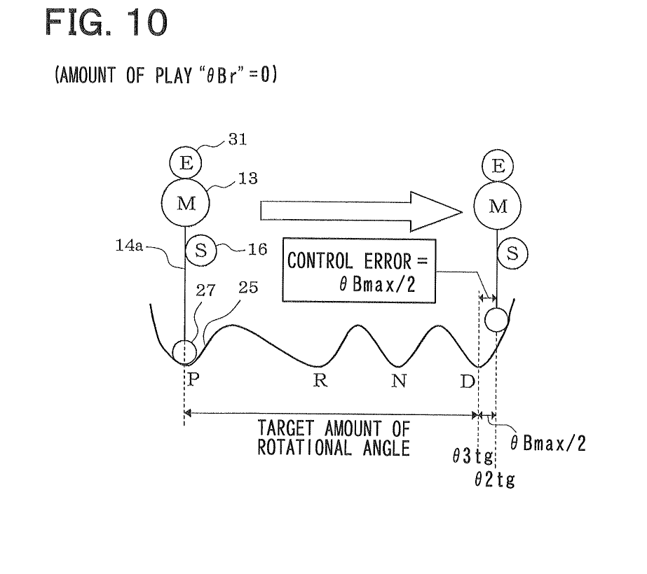

FIG. 10 shows such a case, in which the actual amount of the play “θBr” of the coupling portion 15a is equal to zero “0”.

As shown in FIG. 10, when the shift range is moved from the P-range to the D-range, the stop position of the roller 27 is such a position which is displaced from the center bottom position of the recessed portion 25 for the D-range in the direction toward the D-range by the amount of “θBmax/2”. In other words, the control error for the stop position of the roller 27 is the half (½) of the maximum amount of the play “θBmax”.

In FIGS. 8 (8A and 8B) to 10, the operation of the present embodiment is explained with reference to the example, in which the shift range is moved from the P-range to the D-range. However, in other cases than the above example, namely in cases in which the shift range is moved from the P-range to the R-range or the N-range, from the D-range to the P-range, the R-range or the N-range, the control error likewise becomes the half (½) of the maximum amount of the play “θBmax”.

According to the present embodiment, as above, it is possible to control the control error for the stop position of the roller 27 within the range equal to or smaller than the half (½) of the maximum amount of the play “θBmax”. In other words, it is possible to surely bring the stop position of the roller 27 within the slide-off range. As a result, the roller 27 can be surely moved to the center bottom position of the recessed portion 25.

The above F/B control for the motor 13 is carried out by the ECU 33 in accordance with the processes shown in FIGS. 11 to 14. Hereinafter, the processes will be explained.

### (Main Routine)

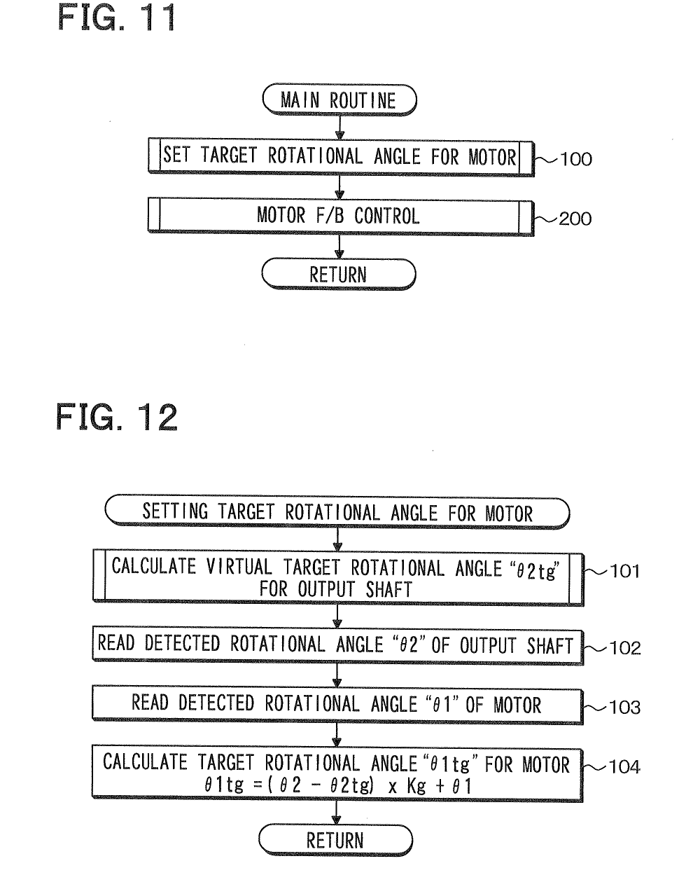

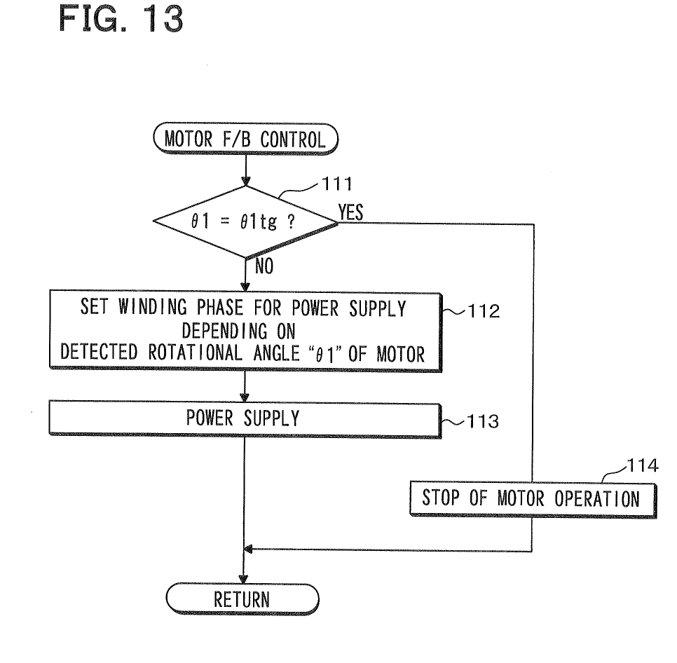

The main routine of FIG. 11 is carried out at a predetermined cycle during a period in which a power supply to the ECU 33 is turned on. When the routine starts, at a step 100, a routine for setting the target rotational angle for the motor (explained below with reference to FIG. 12) will be carried out, so that the target rotational angle “θ1tg” for the motor is decided. Then, the process goes to a step 200, at which a routine for a motor F/B control (explained below with reference to FIG. 13) is carried out. According to the motor F/B control, the motor 13 is driven to rotate to a position of the target rotational angle “θ1tg” for the motor so as to change the shift range of the shift-range changing device 11 to the target range.

### (Routine for Setting the Target Rotational Angle for the Motor)

The routine of FIG. 12 is a sub-routine, which is carried out at the step 100 of the main routine of FIG. 11. The routine of FIG. 12 is also referred to as a setting portion of the target rotational angle for the motor.

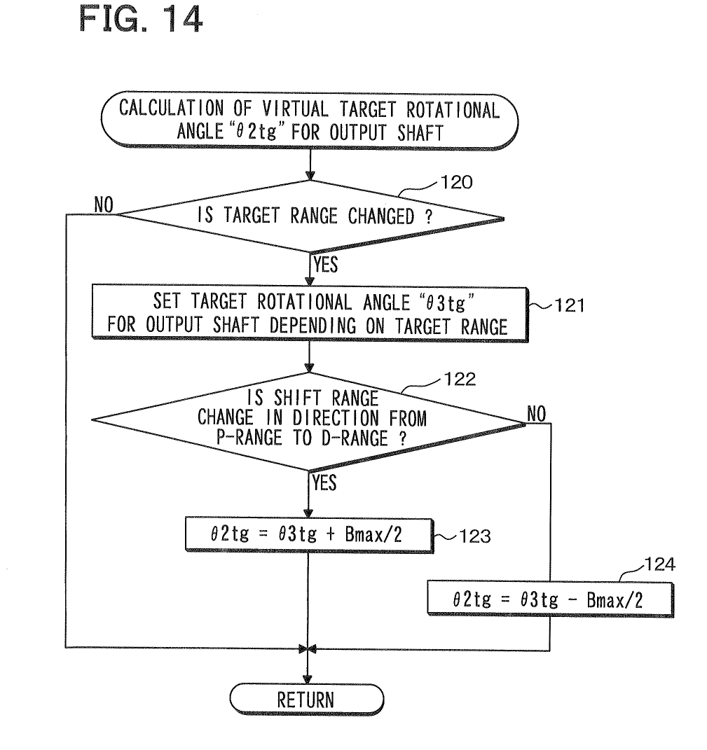

When the routine starts, at a step 101, a routine of FIG. 14 for calculating the virtual target rotational angle “θ2tg” for the output shaft is carried out. At the step 101, the target rotational angle “θ3tg” for the output shaft for the corresponding target range is corrected by the correction amount (θBmax/2), so as to obtain and set the virtual target rotational angle “θ2tg” for the output shaft.

Then, the process goes to a step 102, to read the detected rotational angle “θ2” of the output shaft detected by the output-shaft sensor 16. Then, at a next step 103, the ECU reads the detected rotational angle “θ1” of the motor detected by the encoder 31. The process goes to a step 104 to calculate (and set) the target rotational angle “θ1tg” for the motor in accordance with the following formula:

θ1tg=(θ2−θ2tg)×Kg+θ1

As understood from the above formula, the deviation (θ2-θ2tg) (between the detected rotational angle “θ2” of the output shaft detected by the output-shaft sensor 16 and the virtual target rotational angle “θ2tg” for the output shaft) is multiplied by the reduction ratio “Kg” of the speed reduction gear 14. And then the detected rotational angle “θ1” of the motor detected by the encoder 31 is added to the above multiplied amount to finally get the target rotational angle “θ1tg” for the motor.

### (Routine for the Motor F/B Control)

The routine of FIG. 13 is a sub-routine, which is carried out at the step 200 of the main routine of FIG. 11. When the routine starts, at a step 111, the ECU 33 determines whether the detected rotational angle “θ1” of the motor detected by the encoder 31 is equal to the target rotational angle “θ1tg” for the motor or not. When the detected rotational angle “θ1” of the motor is not equal to the target rotational angle “θ1tg” for the motor, the process goes to a step 112, at which the winding phases of the motor 13 for the current supply are decided (set) depending on the detected rotational angle “θ1” of the motor. Then, the process further goes to a step 113, at which the ECU 33 outputs driving signals to the motor driver circuits 34 and 35, so that the power supply is carried out to the winding phases of the motor decided at the step 112 so as to drive the motor 13.

Thereafter, when the detected rotational angle “θ1” of the motor detected by the encoder 31 becomes equal to the target rotational angle “θ1tg” for the motor, the ECU 33 determines YES at the step 111 and the process goes to a step 114, at which the motor operation is stopped. As above, the operation for changing the shift range of the shift-range changing device is completed.

(Routine for Calculating the Virtual Target Rotational Angle “θ2tg” for the Output Shaft)

The routine of FIG. 14 is a sub-routine, which is carried out at the step 101 of the routine of FIG. 12 for setting the target rotational angle for the motor. When the routine starts, at a step 120, the ECU 33 determines whether the target range is changed or not. When the target range is not changed, the process goes to an end.

Thereafter, when the target range is changed, the process goes to a step 121, at which the ECU 33 calculates and sets the target rotational angle “θ3tg” for the output shaft depending on the target range. The target rotational angle “θ3tg” for the output shaft is calculated (set) based on the current rotational position of the output shaft 14a (that is, the detected rotational angle “θ2” of the output shaft detected by the output-shaft sensor 16) and the target amount of the rotational angle for the output shaft 14a necessary for changing the shift range to the target range (that is, the amount of the rotational angle from the center bottom position of the recessed portion 25 for the current shift range to the center bottom position of the recessed portion 25 for the target shift range).

The process goes to a step 122, at which the ECU 33 determines whether the shift range is changed in a direction from the P-range to the D-range. When it is the shift range change in the direction from the P-range to the D-range, the process goes to a step 123, at which the virtual target rotational angle “θ2tg” for the output shaft is set at such a position, which is displaced from the target rotational angle “θ3tg” for the output shaft for the target range by the correction amount (θBmax/2) in the direction to the D-range:

θ2tg=θ3tg+θBmax/2

On the other hand, when the ECU 33 determines at the step 122 that it is the shift range change in the direction from the D-range to the P-range, the process goes to a step 124, at which the virtual target rotational angle “θ2tg” for the output shaft is set at such a position, which is displaced from the target rotational angle “θ3tg” of the output shaft for the target range by the correction amount (θBmax/2) in the direction to the P-range:

θ2tg=θ3tg−θBmax/2

According to the present embodiment explained as above, the target rotational angle for the motor is set by use of the correction amount, which is in advance decided based on the amount of the play. Therefore, it is not necessary to carry out a process for learning the amount of the play. A calculating load for the ECU 33 can be thereby reduced. In addition, since the correction amount (that is, the constant amount) decided in advance based on the amount of the play is used, a problem of the conventional system, in which a learning error or a detection error for the amount of the play might have occurred, will not occur. It is, therefore, possible to prevent a control accuracy of the shift-range changing device 11 (that is, the control error for the stop position of the roller 27) from largely decreasing. Accordingly, the control accuracy for the shift-range changing device 11 can be properly maintained.

In addition, according to the present embodiment, the amount (θBmax/2) of the rotational angle, which corresponds to the half (½) of the maximum amount of the play “θBmax” (the amount of the play of the coupling portion having the maximum production tolerance), is set as the correction amount. The control accuracy of the shift-range changing device 11 (that is, the control error for the stop position of the roller 27) can be always suppressed to a value equal to or smaller than the half (½) of the maximum amount of the play “θBmax”, irrespectively of an actual size of the amount of the play.

The correction amount should not be limited to the amount of the rotational angle corresponding to the half of the maximum amount of the play “θBmax, but may be modified. For example, the correction amount maybe set to be a value, which is slightly larger or smaller than the amount of the rotational angle corresponding to the half of the maximum amount of the play “θBmax.

According to the shift-range changing device of the present embodiment, the shift range is changed to either one of the P-range, the R-range, the N-range and the D-range. However, shift ranges of a second range (2-range) or a low range (L-range) may be added. Alternatively, the present invention may be further applied to a shift-range changing device having only two shift ranges, which are the P-range and Not-P-range.

The present invention should not be limited to the shift-range changing device, but may be applied to various apparatuses having an electric motor as a driving source.

In the above embodiment, the amount of the play included in the coupling portion 15a is taken into consideration when the target rotational angle “θ1tg” is calculated. However, a mechanical gap, which includes not only the play in the coupling portion (the coupling device) but also a play (a back-lash) and/or a clearance included in the electric motor and/or the speed reduction device (that is, the rotation transmitting system) may be also taken into consideration when calculating the target rotational angle for the electric motor.

What is claimed is:

1. A motor control system comprising:
an electric motor;
a motor position detecting device for detecting a rotational angle of the electric motor;
an output shaft connected to a rotor shaft of the electric motor via a rotation transmitting system;
a controlled device connected to the output shaft via a coupling device; and
a motor control apparatus for setting a target rotational angle for the electric motor, which corresponds to a target operational position of the controlled device when moving an operational position of the controlled device to the target operational position, and the motor control apparatus further driving the electric motor until a detected rotational angle of the electric motor detected by the motor position detecting device becomes equal to or closer to the target rotational angle for the electric motor,
wherein the motor control apparatus has a motor position setting portion for setting the target rotational angle for the electric motor so that the target rotational angle for the electric motor includes a basic rotational angle for the output shaft necessary for moving the operational position of the controlled device to the target operational position and a correction amount.

2. The motor control system according to the claim 1, wherein
the correction amount is such an amount calculated based on a mechanical gap, which is included at least one of the electric motor, the rotation transmitting system and the coupling device.

3. The motor control system according to the claim 2, wherein
the correction amount corresponds to such a correction, according to which the rotational angle of the electric motor is increased, so that the operational position of the controlled device is further moved to be closer to a basic position corresponding to the basic rotational angle of the output shaft or beyond the basic position.

4. The motor control system according to the claim 2, wherein
the correction amount is such an amount calculated based on the mechanical gap, which is included in the coupling device.

5. A motor control system comprising:
an electric motor;
a motor position detecting device for detecting a rotational angle of the electric motor;
an output shaft connected to a rotor shaft of the electric motor via a rotation transmitting system;
a controlled device connected to the output shaft via a coupling device having a play; and
a motor control apparatus for setting a target rotational angle for the electric motor, which corresponds to a target operational position of the controlled device when moving an operational position of the controlled device to the target operational position, and the motor control apparatus further driving the electric motor until a detected rotational angle of the electric motor detected by the motor position detecting device becomes equal to or closer to the target rotational angle for the electric motor,
wherein the motor control apparatus has a motor position setting portion for setting the target rotational angle for the electric motor by use of a correction amount which is calculated based on a predetermined amount of the play.

6. The motor control system according to the claim 5, further comprising:
an output-shaft position detecting device for detecting a rotational angle of the output shaft; and
an output-shaft position setting portion for setting a target rotational angle for the output shaft, corresponding to the target operational position,
wherein the motor position setting portion corrects the target rotational angle for the output shaft by use of the correction amount, calculates a deviation between a corrected target rotational angle for the output shaft and a detected rotational angle of the output shaft detected by the output-shaft position detecting device, multiplies the deviation by a reduction ratio of the rotation transmitting system, and calculates the target rotational angle for the electric motor by use of such a multiplied value.

7. The motor control system according to the claim 6, wherein,
the correction amount is set at such an amount of the rotational angle, which corresponds to a half of the play,
the motor position setting portion corrects the target rotational angle for the output shaft in such a manner that the output shaft is further rotated by the correction amount in addition to the target rotational angle for the output shaft, when the motor position setting portion corrects the target rotational angle for the output shaft by use of the correction amount.

8. The motor control system according to the claim 5, wherein,
the predetermined amount of the play is set to be a value, which corresponds to an amount of a play included in the coupling device having a maximum production tolerance.

9. A motor control system comprising:
an electric motor;
a motor position detecting device for detecting a rotational angle “θ1” of the electric motor;
an output shaft connected to a rotor shaft of the electric motor via a rotation transmitting system;
an output-shaft position detecting device for detecting a rotational angle “θ2” of the output shaft;
a controlled device connected to the output shaft via a coupling device having a play; and
a motor control apparatus for controlling the rotational angle “θ1” of the electric motor so that an operational position of the controlled device is moved to a target operational position,
wherein
the motor control apparatus calculates a target rotational angle “θ3tg” for the output shaft, which corresponds to the target operational position,
the motor control apparatus calculates a virtual target rotational angle “θ2tg” in accordance with a following formula 1;
θ2tg=θ3tg±θBmax/2 formula 1:
wherein “θBmax/2” is a correction amount calculated based on a predetermined amount of the play included in the coupling device,
the motor control apparatus calculates a target rotational angle “θ1tg” for the electric motor in accordance with a following formula 2;
θ1tg=(θ2−θ2tg)×Kg+74 1 formula 2:
wherein “Kg” is a reduction ratio of the rotation transmitting system, and
the motor control apparatus drives the electric motor in a feed-back control so that a detected rotational angle “θ1” of the electric motor becomes equal to or closer to the target rotational angle “θ1tg” for the electric motor.
